(19) United States
(12) Patent Application Publication
(10) Pub. No.: US 2010/0002150 A1
(43) Pub. Date: Jan. 7, 2010

(54) Method and apparatus for turning off a digital television screen when the viewer or an application is running that does not require a display screen

(75) Inventors: William Pat Price, Rhome, TX (US); Timothy Elliott, Hungtington Beach, CA (US); Marcus P. Apitz, Yorba Linda, CA (US); Peter J. Schwartz, Fullerton, CA (US)

Correspondence Address: Law Office of Scott C Harris Inc, PO Box 1389, Rancho Santa Fe, CA, 92067, US

(73) Assignee: Vizio, Inc., Irvine, CA (US)

(21) Appl. No.: 12/166,164

(22) Filed: Jul. 1, 2008

(51) Int. Cl. H04N 5/63; H04N 5/66

(52) U.S. Cl. 348/730; 348/739; 348/E05.127; 348/E05.133

(57) ABSTRACT

A system and apparatus that allows the user or an application to turn off the display screen on a television when said application does not display images while it is active or the viewer is only interested in listening to the audio of a program. An example of this would be playing music received over a cable or satellite set top box or through a plurality of other means through the television speakers. Blanking or turning off the television display screen during this time results in a substantial energy savings. Another example is the viewer only being interested in the audio for a sports program such as basketball or baseball.

### FIELD OF THE INVENTION

The present invention relates to plasma and LCD digital televisions.

### BACKGROUND

The price of digital flat screen television has decreased; while the size of the screens has continued to increase for the same or less cost. LCD and Plasma screen devices are two of the most common technologies. The amount of power these devices consume is considerable.

These devices consume more power as the size of the screen increases. A family with three children may have a LCD screen television in the living room, a plasma screen television in the master bedroom and a LCD television in each of the children's bedrooms and the kitchen, there are a total of 6 televisions which is not inconsistent in today's household. Households typically put newer larger screen televisions in a common area of a home such as the living room with ever decreasing size televisions in the parent's bedroom, oldest child, middle child, and finally the youngest child. Kitchen televisions tend to be the smallest in the house and typically range in the 20 inch size.

FIGS. 1 and 2 use the terms “HDTV” and “FHDTV”. These terms refer to the vertical resolution of the televisions. HDTV is an acronym for “High Definition TV” which has a vertical resolution of 720 lines that are progressively scanned. This is the quality of video typically received through over the air broadcasts. FHDTV is an acronym for “Full High Definition TV” which has a vertical resolution of 1080 lines that are progressively scanned. This type of resolution video is typically available through BluRay players, X-Box and PS-3 game consoles, and some up coding DVD players.

Consider the table shown in FIG. 1. This table shows the typical power consumption of plasma screen televisions. Keeping in mind that older display screens of the same size typically consume more power than newer screens of the same size. FIG. 2 shows the power consumption of LCD screen televisions. These tables show that a typical 32 inch plasma screen television consumes 250 watts when active and a 50 inch plasma screen television as much as 550 watts when active. LCD screen televisions typically consume less power than plasma screen television but given that they are generally less expensive consumers typically purchase more of them and in larger screen sizes.

For the example family with 3 children, the energy budget for all 6 televisions, would typically look like the table in FIG. 3.

### SUMMARY OF THE INVENTION

Embodiments addresses excessive and needless consumption of power by a digital television set when the current running application or the viewer does not require or does not desire to have video presented.

### BRIEF DESCRIPTION OF THE DRAWINGS

Embodiments of the present invention are illustrated by way of example, and not by way of limitation. The following figures and the descriptions both brief and the detailed descriptions of the invention refer to similar elements and in which:

FIG. 1 is a diagram showing the power consumption of various size plasma screen digital televisions.

FIG. 2 is a diagram showing the power consumption of various size LCD screen digital televisions.

FIG. 3 is a diagram showing the power budget for 6 televisions in a household with three children.

FIG. 4 is a diagram depicting an embodiment where the display electronics circuitry manages the power state of the display screen power supply.

FIG. 5 is a diagram depicting the invention where the computing engine in the digital television manages the power state of the display screen power supply.

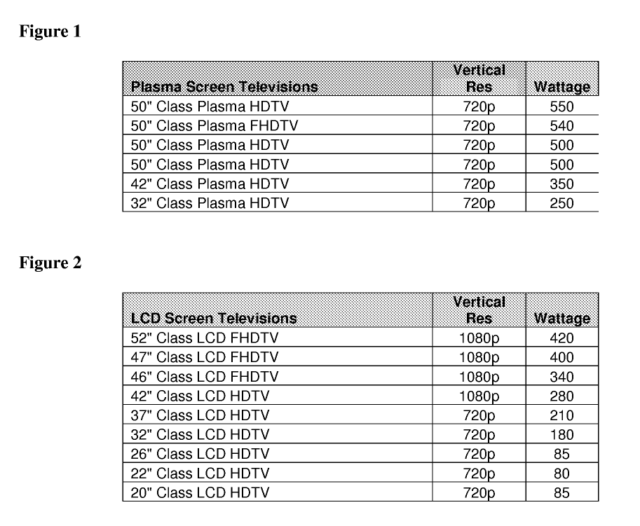

### DETAILED DESCRIPTION

The inventors recognize that the large power consumer in any flat panel television is the panel. The electronics that receive and process the incoming television signals and that drive the signals to the panel consume somewhere around 30 to 50 watts; with the rest of the power budget being consumed by the display.

In current televisions and more certainly in televisions that will be released to the marketplace over the next several years, the televisions will be providing services that do not require that the screen be active. Current televisions that are connected to cable and satellite set top boxes usually have the ability to play music from at least one satellite service such as XM Radio or Sirius. Many people use these services through their television. The music service typically displays the name of the song currently playing but few if any people sit and watch the screen while the music is playing. Using the television as a radio receiver is a gross waste of energy considering the differences in power consumption between the electronics and the screen panel. Televisions of the future will be used for everything from home security to medical monitoring. For many of these services the screen will not be needed.

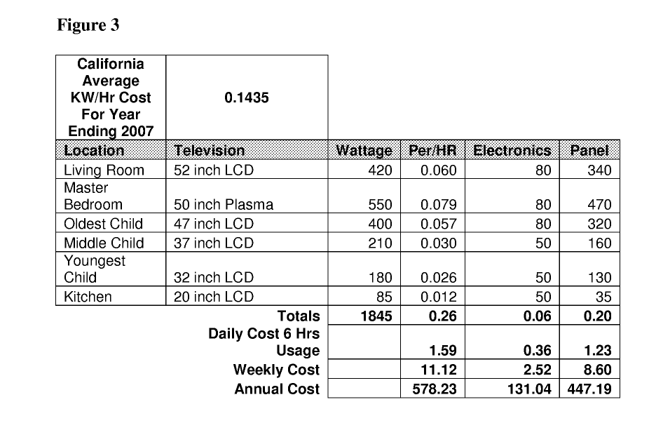

FIG. 3 shows an energy budget for the electronics for all 6 televisions in the example household. This may be approximately 5 to 6 cents per hour for the electronics and approximately 20 cents per hour for the screen panels. These costs were computed from a table located at:

http://www.eia.doe.gov/cneaf/electricity/epm/table5_{—}6_a.html

This web site is a department of energy web site. The table shows the average cost of energy for all states during the period 2006 through 2007.

One can quickly surmise that in California where the average cost for power during 2007 was 0.1435 cents per kilowatt hour, the cost of operating all of the televisions in the example family amounts to $578.23 per year. The cost of power for the electronics for these televisions is $131.04 and the cost of operating the display screens for the same televisions is $447.19. Thus the power for the screens costs 3.4 times what it costs to run the electronics. If the master bedroom television provides music services and/or other services for 2 hours per day where the display screen is not needed for video display then the cost savings per year just for that television amounts to $49.10 per year for power priced at 2007 costs. If one looks at all of the televisions in the household where each television realizes a 2 hour per day period where the display screen is not needed then the savings become more dramatic at $152.00 savings per year. This amounts to about 26% savings per year.

Embodiments directly address the problem with televisions needlessly consuming power when there is no demonstrated need for usage of the power. Embodiments describe either an application to turn-off the television display when it adds no value to the application or the viewer when the viewer is not interested in the video portion of a program and he simply wants to listen to the audio.

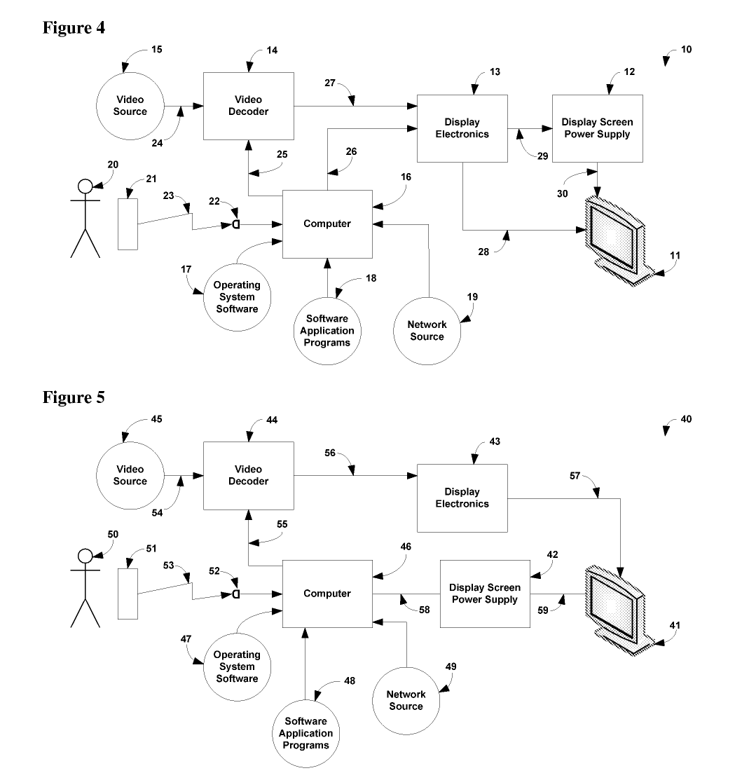

A first embodiment 10 is shown in FIG. 4, where a digital display screen is either a plasma display screen or a LCD display screen shown as 11. Display Screen Power Supply 12 provides Operating Power 30 to Display Screen 11.

Video Decoder 14 receives Digital Video Signal 24 from Video Source 15. Digital Video Signal 24 may be of a plurality of signal types such as MPEG video streams, H.264 video streams or any other digital video stream that contains video and audio together or only video or only audio.

Video Source 15 may be the output from an ATSC radio frequency digital tuner or a DVD player or from a plurality of other sources such as video game consoles, videocassette recorders, cable and satellite set top boxes, cable cards, portable music and video players or other such sources. The term DVD is mean to be “Digital Versatile Disc” or “Digital Video Disc” as commonly known. Video Decoder 14 decodes Digital Video Signal 24 and sends Decoded Video 27 to Display Electronics 13.

Display Electronics 13 converts Decoded Video 27 into Video Display Signals 28 that are compatible for the particular Display Screen 11 which may be either plasma or LCD or some other display technology that requires electrical power to operate.

Computer 16 is controlled by Operating System Software 17. Computer 16 also executes a plurality of Software Application Programs 18. One or more of these application programs can determine if Display Screen 11 is required to present video images to User 20 for the current television application that is being executed. For example, this can be done based on preferences (such as turn off the video during sound-only programs, or during sports-only programs)

If one of Software Application Programs 18 determines that video is not necessary for the current program, Computer 16 sends Control Signal 26 to Display Electronics 13 commanding Display Electronics 13 to turn off Display Screen Power Supply 12. Display Electronics 13 sends On/Off Signal 29 indicating an OFF condition to Display Screen Power Supply 12 which turns off the electrical power to Display Screen 11. When Display Screen Power Supply 12 is turned off, Display Screen 11 will no longer display Display Signals 28 sent to it by Display Electronics 13.

If Display Screen Power Supply 12 is currently off and one of Software Application Programs 18 decides that video should be displayed on Display Screen 11 Computer 16 will send Control Signal 26 to Display Electronics 13 commanding Display Electronics 13 to turn on Display Screen Power Supply 12.Display Electronics 13 will send On/Off Signal 29 indicating ON to Display Screen Power Supply 12 which turns on the electrical power to Display Screen 11. When Display Screen Power Supply 12 is turned on, Display Screen will display Display Signals 28 sent to it by Display Electronics 13.

Viewer 20 may decide that they do not want to view video. Viewer 20 will send a Command 23 to Computer 16 via Remote Control Hand Set 21.

Remote Control handset 21 may send Command 23 to Computer 16 by any of a plurality of transmission means such as Infrared, laser beam, radio frequency, or other transmission means. Remote Control Receiver 22 receives Transmissions 23 from Remote Control Hand Set 21 and presents said transmissions to Computer 16.

If video is currently being displayed on Display Screen 11 and Viewer 20 sends Command 23 indicating VIDEO OFF to Computer 16 via Remote Control Hand Set 21, Computer 16 will send Control Signal 26 to Display Electronics 13 commanding Display Electronics 13 to turn off Display Screen Power Supply 12. Display Electronics 13 will send On/Off Signal 29 indicating OFF to Display Screen Power Supply 12 which turns off the electrical power to Display Screen 11. When Display Screen Power Supply 12 is turned off, Display Screen will no longer display Display Signals 28 sent to it by Display Electronics 13.

If video is not currently being displayed on Display Screen 11 and Viewer 20 wants to view whatever video is available for the current program, Command 23 indicating VIDEO ON is sent to Computer 16 via Remote Control Hand Set 21. Computer 16 then sends Control Signal 26 to Display Electronics 13 commanding Display Electronics 13 to turn on Display Screen Power Supply 12.

Display Electronics 13 sends On/Off Signal 29 indicating ON to Display Screen Power Supply 12 which turns on the electrical power to Display Screen 11.

When Display Screen Power Supply 12 is turned on, Display Screen 11 will display Display Signals 28 sent to it by Display Electronics 13.

Computer 16 may also receive video, audio, and data streams via Network Source 19.

These video and audio streams can contain the same types of streams received from Video Source 15.

When video, audio, or data is received by Computer 16 from Network Source 19, Computer 16 will direct Video Audio Streams 25 to Video Decoder 14. Video Decoder 14 will decode these streams the same as if the stream had been presented from Video Source 15.

Software Application Programs 18 and Viewer 20 via Remote Control Hand Set 21 may disable and enable the display of video on Display Screen 11 for video and data presentation the same as if the video had been received from Video Source 15.

FIG. 5 shows another embodiment in which Display Screen Power Supply 42 is controlled by Computer 46 via Control Signal 58. Computer 46 is controlled by Operating System Software 47.

Computer 46 also executes a plurality of Software Application Programs 48. These application programs can determine if Display Screen 41 is required to present video images to Viewer 50 for the current television application that is being executed.

If one of Software Application Programs 48 determines that video is not necessary for the current program, Computer 46 will send Control Signal 58 indicating OFF to Display Screen Power Supply 42 which turns off the electrical power to Display Screen 41.

When Display Screen Power Supply 42 is turned off, Display Screen 41 will no longer display Display Signals 57 sent to it by Display Electronics 43.

If Display Screen Power Supply 42 is currently off and one of Software Application Programs 48 decides that video should be displayed on Display Screen 41 Computer 46 sends Control Signal 59 indicating ON to Display Screen Power Supply 42 which turns on the electrical power to Display Screen 41.

When Display Screen Power Supply 42 is turned on, Display Screen will display Display Signals 28 sent to it by Display Electronics 43.

Viewer 50 may decide that they do not want to view video. Viewer 50 will send Command 53 to Computer 46 via Remote Control Hand Set 51.

Remote Control Handset 51 may send Command 53 to Computer 46 by any of a plurality of transmission means such as Infrared, laser beam, radio frequency, or other transmission means. Remote Control Receiver 52 receives Transmissions 53 from Remote Control Hand Set 51 and presents said transmissions to Computer 46.

If video is currently being displayed on Display Screen 41 and user sends Transmissions 53 indicating VIDEO OFF to Computer 46 via Remote Control Hand Set 51, Computer 46 will send Control Signal 58 indicating OFF to Display Screen Power Supply 42 which turns off the electrical power to Display Screen 41.

When Display Screen Power Supply 42 is turned off, Display Screen 42 will no longer display Display Signals 57 sent to it by Display Electronics 43.

If video is not currently being displayed on Display Screen 41 and Viewer 50 wants to view whatever video is available for the current program, he will send Transmissions 53 indicating VIDEO ON to Computer 46 via Remote Control Hand Set 51. Computer 46 will then send Control Signal 58 indicating ON to Display Screen Power Supply 12 which turns on the electrical power to Display Screen 41.

When Display Screen Power Supply 42 is turned on, Display Screen 41 will display Display Signals 57 sent to it by Display Electronics 43.

Computer 46 may also receive video, audio, and data streams via Network Source 49. These video and audio streams can contain the same types of streams received from Video Source 45.

When video, audio, or data is received by Computer 46 from Network Source 49, Computer 46 will direct Video Audio Streams 55 to Video Decoder 44. Video Decoder 44 will decode these streams the same as if the stream had been presented from Video Source 45.

Software Application Programs 48 and Viewer 50 via Remote Control Hand Set 51 may disable and enable the display of video on Display Screen 41 for video and data presentation the same as if the video had been received from Video Source 45.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other ways of turning off the video can be used.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be a Pentium class computer, running Windows XP or Linux, or may be a Macintosh computer. The computer may also be a handheld computer, such as a PDA, cellphone, or laptop.

The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

What is claimed is:

1. A television system comprising:
a television display screen;
a display screen power supply comprising:
i. an interface receiving an electrical signal informing said power supply to turn the output power from said power supply on and off;
ii. power supply electronics capable of producing power of a type to power said television display screen;
a digital display electronics module comprising:
i. a receiving electronics interface, receiving decoded video signals and producing at least one output to drive said digital display screen;
ii. an interface receiving an electrical signal informing said module to turn said power supply on or off based on said decoded video signals;
a computer system, controlling a plurality of functions in said digital television system, said computer system comprising a controlling processor, a first software program comprising the operating system used for controlling said controlling processor, and running at least one application software program used for determining the operational state of said digital display screen;
a receiving sensor assembly capable of receiving at least one of a plurality of transmissions from a remote control device, said transmissions from said remote control device including signals comprising commands for said computer system, wherein said computer system translates said commands received via said transmissions from said remote control device and performs a plurality of actions based on the translated command.

2. The method of claim 1 where said receiving sensor receives said commands via infrared signals.

3. The method of claim 1 where said receiving sensor receives said commands via one of a plurality of radio frequency frequencies and at least one of a plurality of protocols.

4. The method of claim 1 where said commands transmitted by said remote control device includes a command directing said digital television system to turn off said digital display screen;

5. The method of claim 1 wherein said commands transmitted by said remote control device includes a command for said digital television system to turn on said digital display screen;

6. The method of claim 1 wherein said computer runs application software programs which directs said computer to send a signal to said digital display electronics module, where said signal directs said digital display electronics module to turn said display screen power supply output power off but to continue processing said received decoded video signals.

7. The method of claim 6 where an application software program directs said computer to send a signal to said digital display electronics module, where said signal directs said digital display electronics module to turn said display screen power supply output power off and to stop processing any received decoded video signals that are received.

8. The method of claim 7 where an application software program directs said computer to send a signal to said display electronics module where said signal directs said digital display electronics module to turn said display screen power supply output power on.

9. The method of claim 7 where an applications software program directs said computer to send a signal to said display electronics module where said signal directs said digital display electronics module to turn said display screen power supply output power on and to begin processing said received decoded video signals.

10. A digital television system comprising:
a display screen;
a display screen power supply, connected to power said display screen and comprising an interface receiving an electrical signal informing said power supply to turn the output power from said power supply on and off, and power supply electronics capable of powering said digital display screen;
a digital display electronics module comprising a receiving electronics interface receiving decoded video signals and electronics, processing said received decoded video signals, such that processed signals are used by said module to drive said digital display screen;
a computer system for controlling a plurality of functions in said digital television system comprising a controlling first microprocessor, a first software program comprising an operating system used for controlling said first microprocessor, and at least one application software program used for determining an operational state of said digital display screen;
a receiving sensor assembly capable of receiving at least one of a plurality of transmissions from a remote control device, said transmissions from said remote control device contains signals comprising commands, and wherein said first microprocessor translates said commands received via said transmissions from said remote control device and performs a plurality of actions based on the translated command.

11. The system of claim 10 where one of a plurality of said applications software programs directs said first microprocessor to send a signal to said display screen power supply directing said display screen power supply to turn its output power off based on a command received over said receiving sensor assembly.

12. The system of claim 10 where, based on a command received over said receiving sensor assembly, one of a plurality of said applications software programs directs said first microprocessor to do both of:
a. send a signal to said display screen power supply directing said display screen power supply to turn its output power off; and
b. send a signal to said digital display electronics module where said signal directs said digital display electronics module to stop processing said received decoded video signals.

13. The system of claim 10 where one of a plurality of said applications software programs directs said first microprocessor to send a signal to said display screen power supply directing said display screen power supply to turn its output power on, based on a command received over said receiving sensor assembly.

14. The system of claim 10 where one of a plurality of said applications software programs directs said first microprocessor to do both of:
a. send a signal to said display screen power supply directing said display screen power supply to turn its output power on;
b. send a signal to said digital display electronics module where said signal directs said digital display electronics module to begin processing said received decoded video signals, based on a command received over said receiving sensor assembly.

15. The system of claim 10 where one of a plurality of said applications software programs detects information from said decoded video signals, and determines automatically from said information whether said video screen needs to be on based on said information, and directs said first microprocessor to send a signal to said display screen power supply directing said display screen power supply to turn its output power off based on said determines.
